(19) United States
(12) Patent Application Publication
(10) Pub. No.: US 2022/0087782 A1
(43) Pub. Date: Mar. 24, 2022

(54) ORTHODONTIC DEVICE

(71) Applicant: ZE FANG LTD., New Taipei City (TW)

(72) Inventors: Chih-Chang Tsai, New Taipei City (TW); Yi-Wen Chen, New Taipei City (TW)

(21) Appl. No.: 17/030,384

(22) Filed: Sep. 24, 2020

(51) Int. Cl. A61C 7/30

(52) U.S. Cl. CPC A61C 7/30

(57) ABSTRACT

An orthodontic device has a main structure that includes an orthodontic body including a base portion, a support trough portion, and a joining portion and also includes a positioning engagement slot formed on the orthodontic body and located between the base portion and the joining portion, two guiding slopes formed on side walls of the positioning engagement slot, a closing portion formed at an end of the positioning engagement slot and connecting the guiding slopes, an elastic cover body movably arranged on the orthodontic body, and two elastic clips extended from and formed on an end of the elastic cover body. The elastic cover body is arranged to shield and cover the support trough portion of the orthodontic body and the elastic clips formed at an end thereof are insertable into the positioning engagement slot as being positioned by the guiding slopes.

### TECHNICAL FIELD OF THE INVENTION

The present invention relates to an orthodontic device, and more particularly to an orthodontic device featuring simplification of structure, easiness of operation, and being sanitary and easy to maintain.

### DESCRIPTION OF THE PRIOR ART

The demand for improving living quality makes people place more attention on the appearance, and having health, beautiful, and well-functioning teeth, dentition, and face could help people to expand social circle, increase the opportunity of job offering, and enhance self-confidence. Thus, orthodontics, dentition correction, and teeth straightening are prevailing, which, in addition to improving dental healthy, help create a beautiful smile that a person likes to share with other people. This makes the application of orthodontic equipment increasingly common and popular.

Dental braces are most commonly used and include slide-cover self-ligating braces and locking self-ligating braces. The slide-cover self-ligating brace requires a very complicated process for both fabrication and installation. The self-ligating brace having a slidable fastening element cannot be fabricated with an affordable cost and efficiency. The fastening element, after multiple times of opening and closing, would lose the fastening power, making it unusable. Further, it is hard to control the force that is used to open and close the fastening element. For an excessively small force, it may not be possible to retain the closing position, making it not possible to securely retain the corrective wire; and for an excessive large force, it may cause damage of the brace or make the patient uncomfortable.

The locking self-ligating brace includes a locking plate structure having high elasticity. The locking plate structure, after being closed, generates an elastic compression force that acts on the corrective wire, persistently applying a moderate correction force. However, there is inevitably corners and gaps that occur in the locking brace, resulting from the space for insertion of the locking plate structure. However, the brace has only a very limited size, and to make use of such a space to fix the locking plate structure, it needs an elongated through hole to retain the locking plate structure in the inside. The end of the through hole that is penetrated by the locking plate structure, due to being not blocked by the locking plate structure itself, may easily catch food residues and cause accumulation of dental bacterial plaque, making the oral cavity exposed to a severe environment.

### SUMMARY OF THE INVENTION

The primary objective of the present invention is to use an elastic cover body that has a simple structure to shield and cover a support trough portion of an orthodontic body and to provide elastic clips that are insertable into a positioning engagement slot as being positioned by guiding slopes, with an end of the positioning engagement slot being a closing portion, so that the drawbacks of the slide-cover fashion device can be alleviated and issues concerning bacterial breeding in the positioning engagement slot can be reduced.

To achieve the above objective, a primary structure of the present invention comprises: an orthodontic body, wherein orthodontic body comprises a base portion, a support trough portion, and a joining portion, the support trough portion being formed on the base portion, the joining portion being formed on one side of the base portion that is opposite to the support trough portion, and also comprises a positioning engagement slot, two guiding slopes, a closing portion, an elastic cover body that shields and covers the support trough portion, and two elastic clips insertable into the positioning engagement slot and contactable and engageable with the guiding slopes, the positioning engagement slot being formed on the orthodontic body and located between the base portion and the joining portion, the guiding slopes being formed on side walls of the positioning engagement slot, the closing portion being formed at an end of the positioning engagement slot and connecting the guiding slopes, the elastic cover body being movably arranged on the orthodontic body, the elastic clips being extended from and formed on an end of the elastic cover body.

When a user uses the present invention for tooth correction, the joining portion is used to fix the orthodontic body to a tooth surface, while the corrective wire is positioned in the support trough portion to realize correction. The user may operate the elastic cover body to exhibit a state of opening or shielding the support trough portion. In the shielding state of the elastic cover body, the elastic clips are received in the positioning engagement slot, wherein except an opening for the insertion of the elastic clips, another end of the positioning engagement slot is closed by the closing portion, so that food residue jamming in the positioning engagement slot can be avoided. To change the elastic cover body to the open state, the elastic clips are forcibly pulled out of the positioning engagement slot. Since the guiding slopes are arranged at two opposite side and the positioning engagement slot is made in a configuration of which an inner end is enlarged and an outer end is narrowed, the elastic clips, when subjected to an outward-pulling force, are constrained by the guiding slopes and cannot not be completely removed out, but instead, are set in abutting engagement with the guiding slopes of the two sides to achieve an effect of positioning of the elastic cover body. In this way, an operation fixing of a corrective wire by the orthodontic body can be achieved with a simple structure.

With the above-described technique, the drawbacks of the prior art dental braces that the fabrication cost is high, the operation force cannot be properly controlled, and food residue may be easily accumulated to cause breeding of bacteria can be overcome to provide practical improvement for the above-mentioned advantages.

### BRIEF DESCRIPTION OF THE DRAWINGS

FIG. 1 is a perspective view showing a preferred embodiment of the present invention.

FIG. 2 is a perspective view, taken from a different perspective, showing the preferred embodiment of the present invention.

FIG. 3 is a cross-sectional view of the preferred embodiment of the present invention taken along line A-A of FIG. 1.

FIG. 4 is a cross-sectional view of the preferred embodiment of the present invention taken along line B-B of FIG. 1.

FIG. 5 is a schematic view showing an operation of the preferred embodiment of the present invention.

FIG. 6 is another schematic view showing the operation of the preferred embodiment of the present invention.

FIG. 7 is an exploded view illustrating another preferred embodiment of the present invention.

FIG. 8 is a schematic view showing a use of said another embodiment of the present invention.

FIG. 9 is a perspective view illustrating a further preferred embodiment of the present invention.

FIG. 10 is a schematic view showing an operation of said further preferred embodiment of the present invention.

FIG. 11 is a schematic view showing an operation of yet a further preferred embodiment of the present invention.

### DETAILED DESCRIPTION OF THE PREFERRED EMBODIMENT

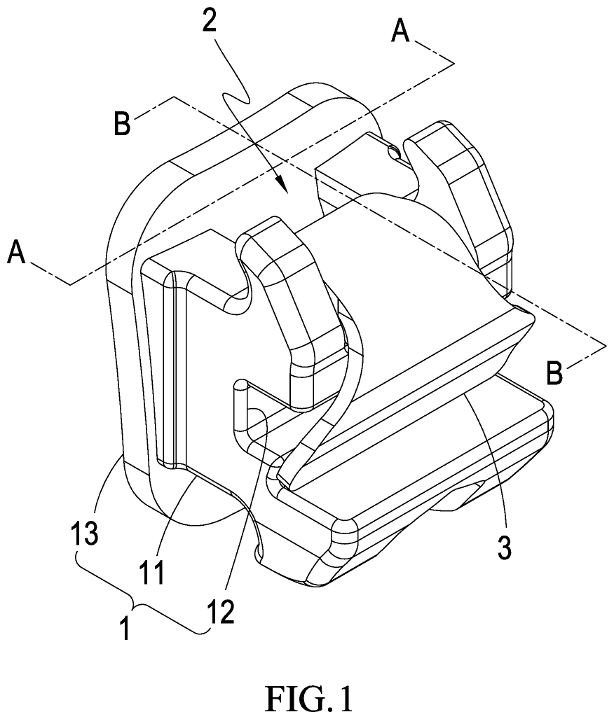

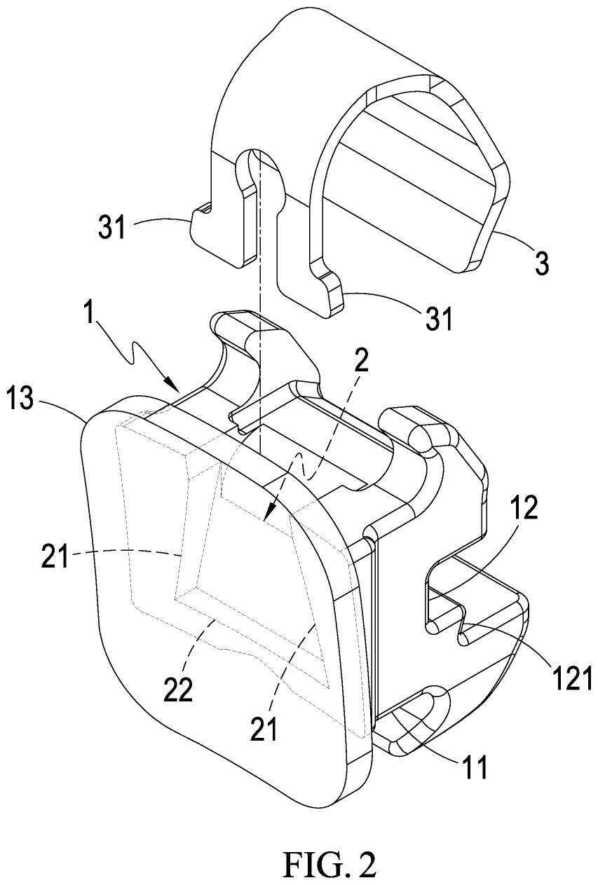

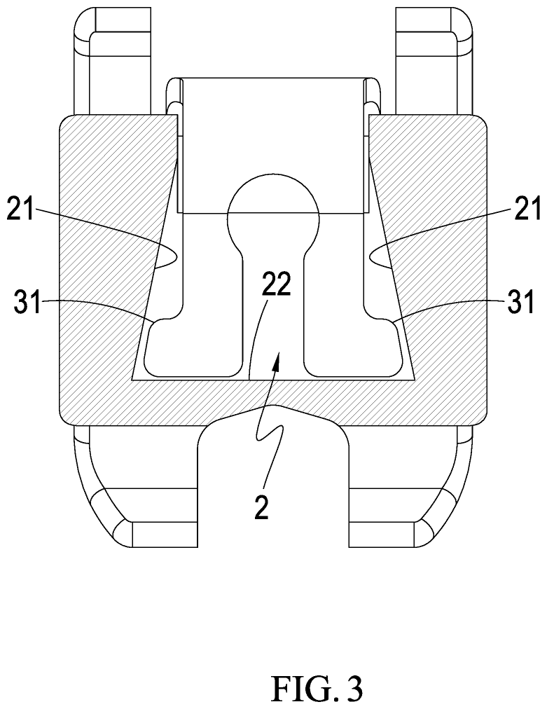

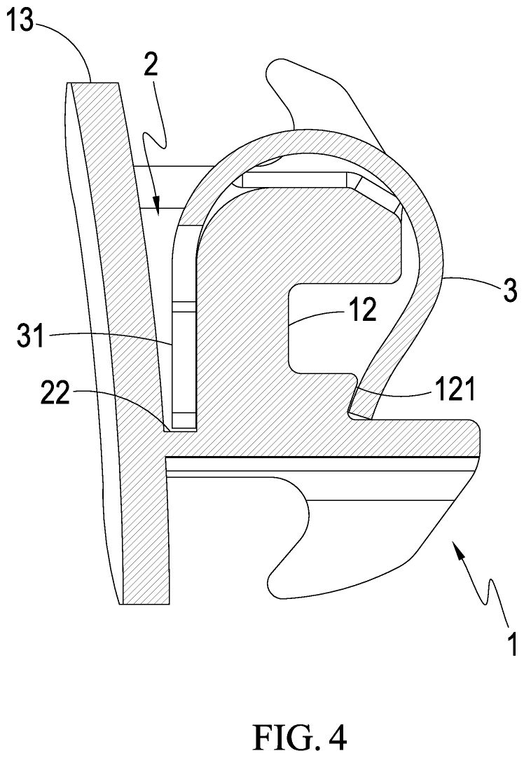

Referring to the illustrations of FIGS. 1-4, which are respectively a perspective view showing a preferred embodiment of the present invention, a perspective view, taken from a different perspective, showing the preferred embodiment of the present invention, a cross-sectional view of the preferred embodiment of the present invention taken along line A-A of FIG. 1, and a cross-sectional view of the preferred embodiment of the present invention taken along line B-B of FIG. 1, these drawings clearly show that the present invention comprises:

an orthodontic body 1, the orthodontic body 1 comprising a base portion 11, a support trough portion 12 formed on the base portion 11, and a joining portion 13 formed on one side of the base portion 11 that is opposite to the support trough portion 12;

a positioning engagement slot 2 formed on the orthodontic body 1 and located between the base portion 11 and the joining portion 13;

two guiding slopes 21 formed on side walls of the positioning engagement slot 2;

a closing portion 22 formed at an end of the positioning engagement slot 2 and connecting the guiding slopes 21;

an elastic cover body 3 movably attachable to the orthodontic body 1 to shield and cover the support trough portion 12;

two elastic clips 31 extended from and formed on an end of the elastic cover body 3 and insertable into the positioning engagement slot 2 and contactable with the guiding slopes 21; and

a stop portion 121 formed on a side wall of the support trough portion 12 to limit extent of inward retraction of the elastic cover body 3.

The above description provides an understanding to the structure of the present invention, and based on collaborative correspondence of such a structure, advantages in respect of structural simplification, operation convenience, and being sanitary and easy to maintain can be achieved. A detailed description will be provided below.

Referring collectively to the illustrations of FIGS. 1-6, which are respectively a perspective view showing a preferred embodiment of the present invention, a perspective view, taken from a different perspective, showing the preferred embodiment of the present invention, a cross-sectional view of the preferred embodiment of the present invention taken along line A-A of FIG. 1, a cross-sectional view of the preferred embodiment of the present invention taken along line B-B of FIG. 1, a schematic view showing an operation of the preferred embodiment of the present invention, and another schematic view showing the operation of the preferred embodiment of the present invention, these drawings clearly show that the orthodontic body 1 is integrally formed as a unitary structure, of which a material is one of a metallic material, a ceramic material, a high-molecule plastic material, or a light-transmitting material and at least comprises the base portion 11 that serves as a structural main body, the joining portion 13 that provides a relatively large cementing area for joining with a tooth surface, and the support trough portion 12 that receives a corrective wire 4 to be positioned therein, wherein an operation of joining the orthodontic body 1 and the tooth surface and an operation of positioning the corrective wire 4 into the support trough portion 12 are both known operations in the art and no description will be provided herein. The positioning engagement slot 2 (including the guiding slopes 21 and the closing portion 22) and the stop portion 121 are formed as being integrally structured with the orthodontic body 1. The elastic cover body 3 may include a material possessing elasticity, such as a metal plate or a stiff plastic body. If a light-transmitting material is used for the orthodontic body 1, the elastic cover body 3 may be also selected as a light-transmitting material, and the elastic clips 31 are each an elastic arm structure that is formed as being integrally extended from the end of the elastic cover body 3.

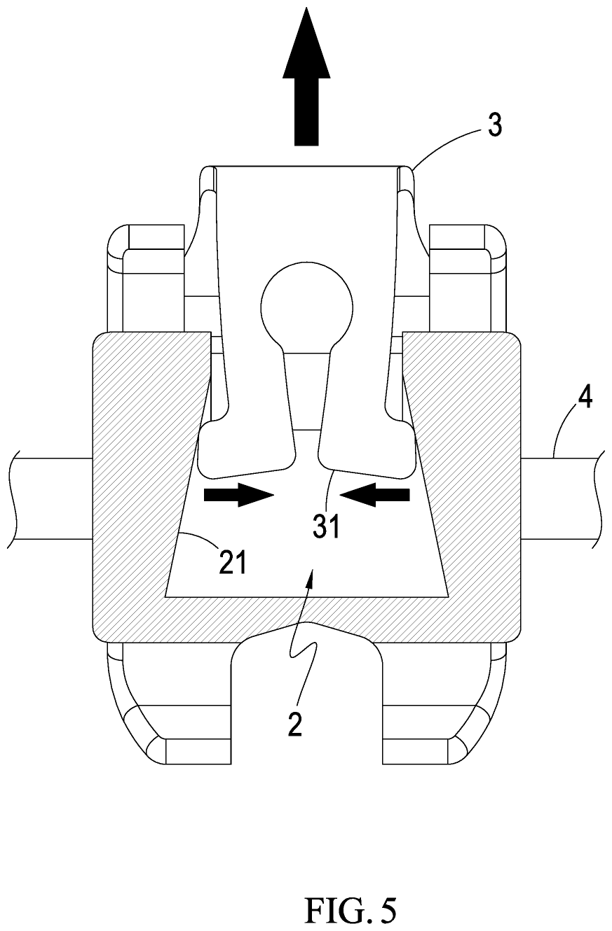

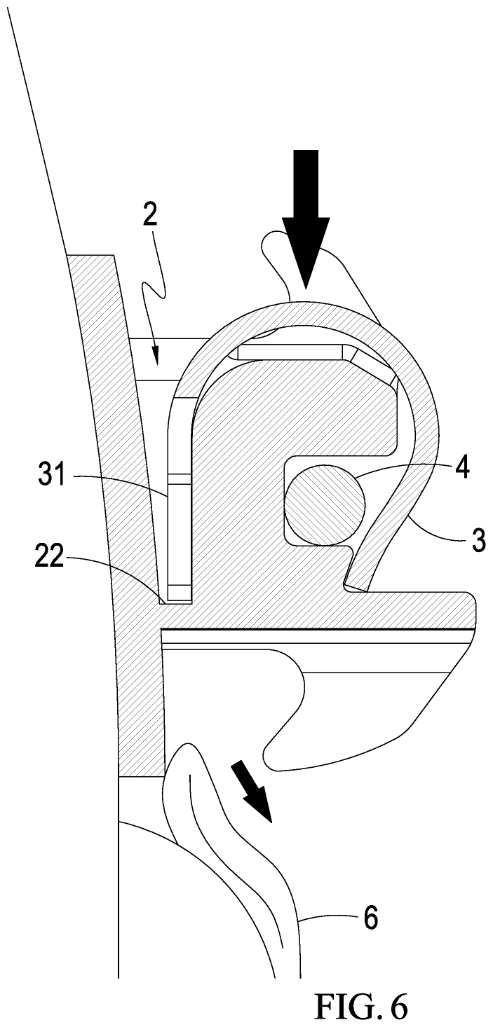

To open the support trough portion 12, a user may operate the elastic cover body 3 to move from a shielding or covering state to an open state. As shown in FIG. 5, in a condition to open the elastic cover body 3, the elastic clips 31 are received and located in the positioning engagement slot 2, and since the positioning engagement slot 2 is formed as being recessed into the base portion 11, with the entirety thereof in the form of a tunnel of which the two side walls are respectively defined by the guiding slopes 21, showing the form of a tunnel having a diverging configuration that is enlarged at an inner end and narrowed at an outer end, the elastic clips 31 are constrained by the guiding slopes 21 and thus trapped and undetachable therefrom, wherein simultaneous contacting and engagement with the guiding slopes 21 on the two sides provides an effect of positioning of the elastic cover body 3. For the user, to close the elastic cover body 3 means pushing the elastic cover body 3 inward, so that the elastic cover body 3 uses the restoration spring force as being flexed inward to resume contact engagement with the stop portion 121, and at the same time, applying a force to hold the corrective wire 4, so that an operation of retaining or fixing the corrective wire 4 by the orthodontic body 1 can be realized with such a simple structure. As shown in FIG. 6, since a bottom of the positioning engagement slot 2 is provided with the closing portion 22, except the opening for insertion of positioning engagement slot 2, there is no other opening for entry or exit, and since the only opening is used to receive the insertion and disposition of the elastic cover body 3, food residue 6 jamming in the positioning engagement slot 2 can be avoided.

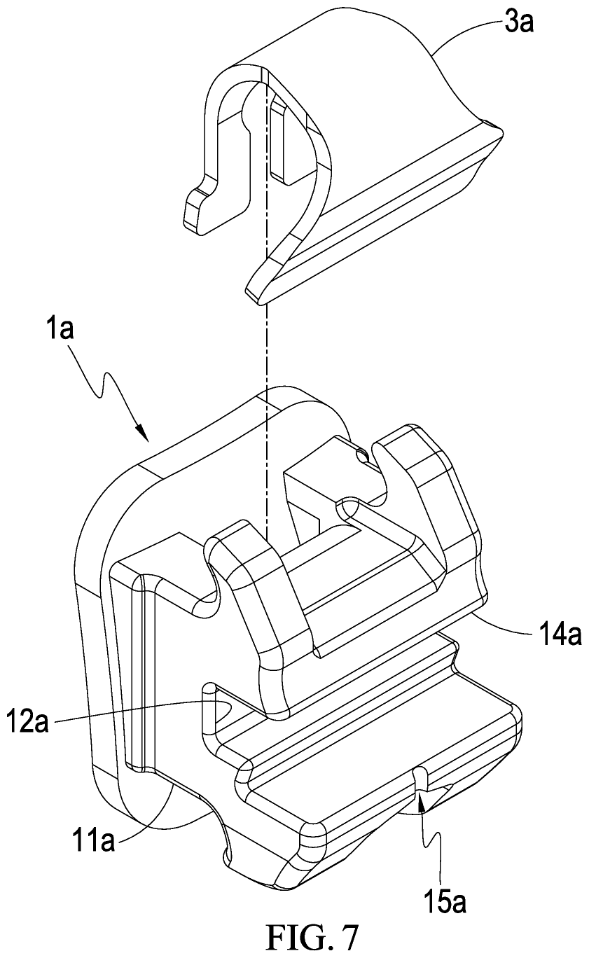

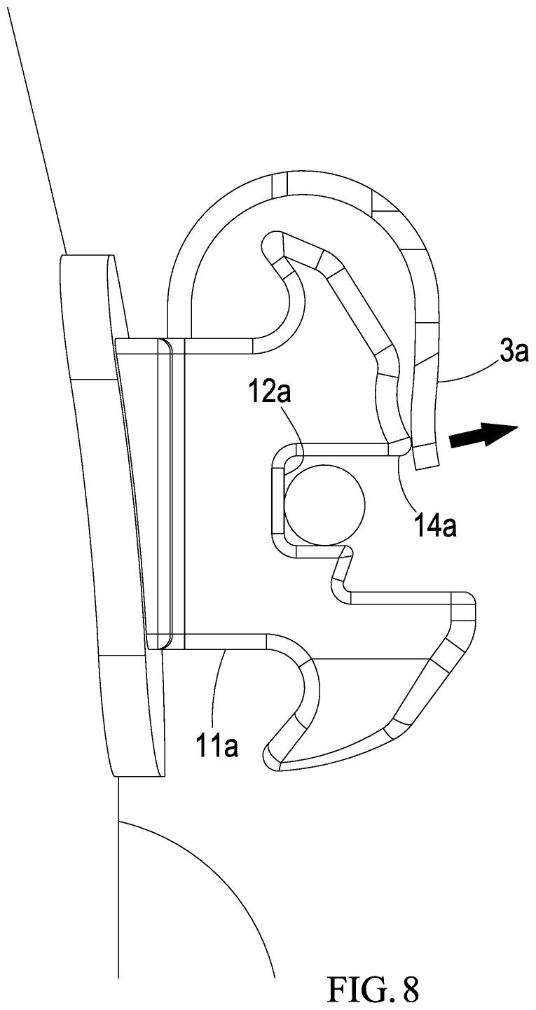

Referring to FIGS. 7 and 8, which are respectively an exploded view illustrating another preferred embodiment of the present invention and a schematic view showing a use of said another embodiment of the present invention, these drawings clearly show that the instant embodiment is similar to the previous embodiment and a difference resides in that the base portion 11a is formed with a supporting portion 14a adjacent to one side of the support trough portion 12a to support, through outward pushing, the elastic cover body 3a, and the base portion 11a is provided with a positioning indicator portion 15a. The supporting portion 14a is located at an upper edge of the support trough portion 12a and is formed in a manner as being slightly projecting relative to the base portion 11a, so that with the arrangement of the supporting portion 14a, an upward supporting force is provided for the elastic cover body 3a being set in movement above the support trough portion 12a to prevent the elastic cover body 3a from directly penetrating into the support trough portion 12a due to an excessively large returning force. Further, since the supporting portion 14a has only a minor effect on the positioning of the elastic cover body 3a, a front end of the elastic cover body 3a, when away from the supporting portion 14a, is still flexible downward to enhance convenience of operation. Further, the positioning indicator portion 15a is made as an indication line in the form of a recessed notch formed on a surface of the base portion 11a, and can be used to indicate the direction of the orthodontic body 1a to provide the user with a reference for identifying the direction in mounting the orthodontic body 1a.

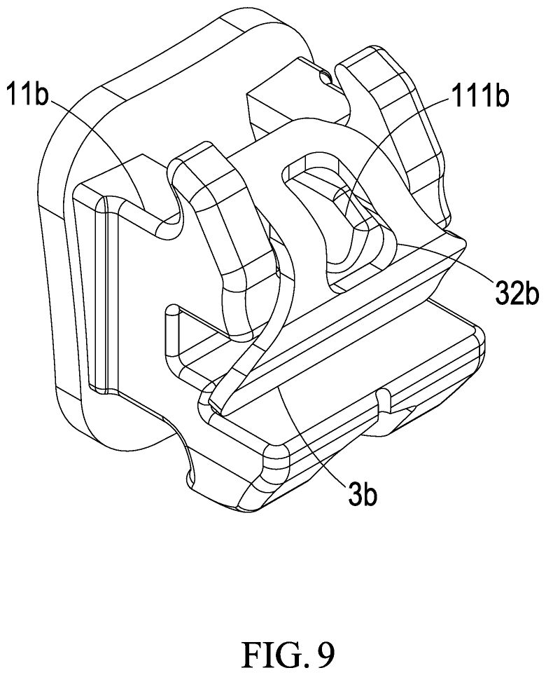

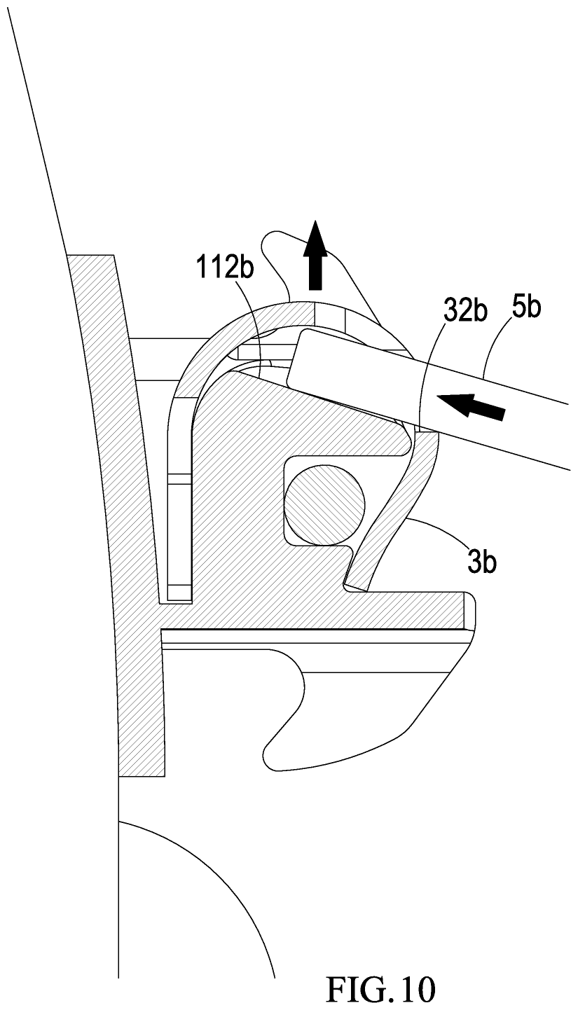

Referring to FIGS. 9 and 10, which are respectively a perspective view illustrating a further preferred embodiment of the present invention and a schematic view showing an operation of said further preferred embodiment of the present invention, these drawings clearly show that the instant embodiment is similar to the previous embodiments and a difference resides in that the elastic cover body 3b is formed with a through-hole portion 32b, and the base portion 11b is provided with a traction notch 111b corresponding, in position, to the through-hole portion 32b. Since the elastic cover body 3b is of a very small size, it may be hard for application of force in an actual operation. A pin 5b may be used in such a way that the pin 5b is set through the through-hole portion 32b and penetrates into the traction notch 111b to allow a force to be directly applied to the pin 5b, and by applying an external force to the pin 5b in a direction (as indicated by arrow) opposite to an operation direction of shielding or covering of the elastic cover body 3b, the elastic cover body 3b can be easily driven to move backward, allowing for easy operation by the user and also reducing discomfort of a patient. Further, the traction notch 111b may be provided with an inclined surface 112b, which is inclined in a direction for guiding a moving direction of the pin 5b. In other words, the user inserts the pin 5b in a right direction into the through-hole portion 32b and the traction notch 111b, and the inclined surface 112b automatically guides the pin 5b to move in a direction of opening the elastic cover body 3b, allowing for easy operation by the user and also helping reducing the effort required for opening the elastic cover body 3b, and also reducing discomfort of the patient.

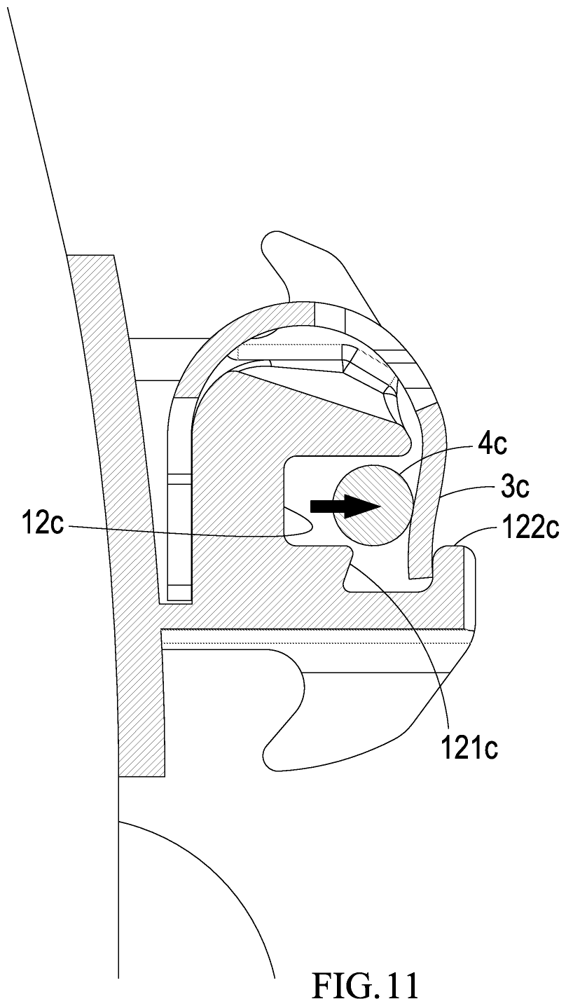

Referring to FIG. 11, which is a schematic view showing an operation of yet a further preferred embodiment of the present invention, the drawing clearly shows that the instant embodiment is similar to the previous embodiments and a difference resides in that the support trough portion 12c is provided with a position-limiting portion 122c located above the stop portion 121c for constraining the extent of outward expansion of the elastic cover body 3c. Since the corrective wire 4c is only retained in position using the spring force of the elastic cover body 3c, if the corrective wire 4c is pulled by an external force, the elastic cover body 3c would be lifted upwards. If this is not a condition of normal operation of the elastic cover body 3c by a use (such as the corrective wire 4c being pulled during tooth picking), then there may be risk of affecting the result of tooth correction. Thus, using the position-limiting portion 122c to shield the space above the elastic cover body 3c would help prevent the elastic cover body 3c from being undesirably over-lifted and eliminate the risk of detachment of the corrective wire 4c in a non-normal operation.

I claim:

1. An orthodontic device, mainly comprising:
an orthodontic body, the orthodontic body comprising a base portion, a support trough portion formed on the base portion, and a joining portion formed on one side of the base portion that is opposite to the support trough portion;
a positioning engagement slot formed on the orthodontic body and located between the base portion and the joining portion;
two guiding slopes formed on side walls of the positioning engagement slot;
a closing portion formed at an end of the positioning engagement slot and connecting the guiding slopes;
an elastic cover body movably attachable to the orthodontic body to shield and cover the support trough portion; and
two elastic clips extended from and formed on an end of the elastic cover body and insertable into the positioning engagement slot and contactable with the guiding slopes.

2. The orthodontic device according to claim 1, wherein the elastic cover body comprises a through-hole portion, and the base portion comprises a traction notch that corresponds, in position, to the through-hole portion.

3. The orthodontic device according to claim 2, wherein the traction notch comprises an inclined surface.

4. The orthodontic device according to claim 1, wherein the base portion comprises a supporting portion adjacent to one side of the support trough portion for outward pushing the elastic cover body.

5. The orthodontic device according to claim 1, wherein the support trough portion has a side wall that comprises a stop portion for limiting an extent of inward retraction of the elastic cover body.

6. The orthodontic device according to claim 5, wherein the support trough portion comprises a position-limiting portion located above the stop portion to constrain an extent of outward expansion of the elastic cover body.

7. The orthodontic device according to claim 1, wherein the base portion comprises a positioning indicator portion.

8. The orthodontic device according to claim 1, wherein the orthodontic body and the elastic cover body comprise light-transmitting materials.
